(19) United States
(12) Patent Application Publication
(10) Pub. No.: US 2008/0200072 A1
(43) Pub. Date: Aug. 21, 2008

(54) COMMON INTERFACE FOR UNIVERSAL SERIAL BUS (USB) AND SERIAL ADVANCED TECHNOLOGY ATTACHMENT (SATA)

(75) Inventor: Woo-seong CHEONG, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/025,968

(22) Filed: Feb. 5, 2008

(30) Foreign Application Priority Data
Feb. 16, 2007 (KR) 2007-16794

(51) Int. Cl. H01R 24/00

(52) U.S. Cl. 439/660

(57) ABSTRACT

A Universal Serial Bus/Serial Advanced Technology Attachment (USB/SATA) common interface Includes a USB/SATA common connector plug having a pin substrate, a plurality of USB contact terminals, and a plurality of SATA contact terminals. The pin substrate is formed of a non-conductive material. The USB contact terminals are formed in a first pattern on a first surface of the pin substrate. The SATA contact terminals are formed in a second pattern which is different from the first pattern, on a second surface of the pin substrate. Therefore, the USB/SATA common interface formed with the USB contact terminals and SATA contact terminals respectively having different patterns in a single plug or in a single socket reduces a layout size of a device and saves resources.

### CROSS-REFERENCE TO RELATED APPLICATIONS

This application claims priority under 35 U.S.C. §119(a) from Korean Patent Application No. 10-2007-0016794, filed on Feb. 16, 2007, in the Korean Intellectual Property Office, the disclosure of which is incorporated herein in its entirety by reference.

### BACKGROUND OF THE INVENTION

1. Field of the Invention

The present general inventive concept relates to an interface between a host apparatus and a storage medium, and more particularly, to a connector plug, a socket, and a connection device which are used in common by a Universal Serial Bus (USB) and a Serial Advanced Technology Attachment (SATA), and a host apparatus and a storage medium including the connector plug, the socket, and the connection device.

2. Description of the Related Art

A Universal Serial Bus (USB) means a cable, a socket, a connector plug, etc., for inserting a USB storage medium, such as a memory stick, a wireless LAN card, etc., into a USB port of a personal computer, a notebook, a Personal Digital Assistant (PDA), and the like. Likewise, a Serial Advanced Technology Attachment (SATA) interface means a cable, a socket, a connector plug, etc., for connecting a host with a SATA storage medium for data transmission.

FIGS. 1A and 1B illustrate a USB connector plug and a SATA connector plug, respectively.

The USB connector plug of FIG. 1A has a structure different from than the SATA connector plug of FIG. 1B. Specifically, in the USB connector plug, a slot UHOM for blind matching is formed in a rectangular shape at an upper part of the USB connector plug such that a height h1 is lower than a height h2. However, in the SATA connector plug, a slot SHOM for blind matching is formed in a “ [symbol] ”-shape, that is, a rectangular shape with a groove at one side.

FIGS. 2A and 2B are a plan view and a cross-sectional view illustrating contact terminals of a USB connector plug and a USB socket, respectively. FIGS. 3A and 3B are a plan view and a cross-sectional view illustrating contact terminals of a SATA connector plug and a SATA socket, respectively.

Referring to FIGS. 1A through 3B, the number and pattern of the contact terminals of the USB connector plug are different from the number and pattern of the contact terminals of the SATA connector plug. In detail, the USB connector plug and the USB socket each has 4 contact terminals (UPP, USP), and the SATA connector plug and the SATA socket each has 7 contact terminals (SPP, SSP).

Also, if the USB contact terminals are formed in a plug, each contact terminal has a flat contact, and if the USB contact terminals are formed in a socket, each contact terminal has a convex contact. Meanwhile, if the SATA contact terminals are formed in a plug, each contact terminal has a convex contact, and if the SATA contact terminals are formed in a socket, each contact terminal has a flat contact.

Accordingly, a USB interface and a SATA interface are separately equipped. However, due to development of mobile devices and minimization of devices, an interface connector which can be used by both a USB interface and a SATA interface is needed.

### SUMMARY OF THE INVENTION

The present general inventive concept provides a common interface which can be used by both a Universal Serial Bus (USB) interface and a Serial Advanced Technology Attachment (SATA) interface.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a Universal Serial Bus/Serial Advanced Technology Attachment (USB/SATA) common connector plug for interfacing between a host apparatus and a storage medium, including a housing, a pin substrate connected to the housing and formed of a non-conductive material, a plurality of USB contact terminals formed in a first pattern on a first surface of the pin substrate, and a plurality of SATA contact terminals formed in a second pattern which is different from the first pattern, on a second surface of the pin substrate.

The first pattern may be a flat pattern, and the second pattern may be a convex pattern. The first surface and the second surface of the pin substrate may lie opposite to each other.

The USB/SATA common connector plug may further include a movable cover connected to the housing and protecting the USB contact terminals. The USB/SATA common connector plug may further include a movable cover connected to the housing and protecting the SATA contact terminals.

The housing may include a slot for blind matching of a USB interface and a SATA interface.

The USB/SATA common connector plug further includes a housing including a slot for blind matching of a USB interface and of a SATA interface and connected to the pin substrate. The first surface of the pin substrate may be located near one surface of the housing. The slot for blind matching may be located near one part of the housing. The slot for blind matching may be formed in a “ [symbol] ”-shape.

The foregoing and/or other aspects and utilities of the present general inventive concept may also be achieved by providing a Universal Serial Bus/Serial Advanced Technology Attachment (USB/SATA) common cable including the USB/SATA common connector plug of above.

The foregoing and/or other aspects and utilities of the present general inventive concept may also be achieved by providing a Universal Serial Bus/Serial Advanced Technology Attachment (USB/SATA) common socket for interfacing between a host and a storage medium, including: a housing: a plurality of USB contact terminals formed in a second pattern on a first surface of the housing; and a plurality of SATA contact terminals formed in a first pattern which is different from the second pattern, on a second surface of the housing.

The USB/SATA common socket may further include, when the USB/SATA common socket is connected to one of a USB interface and a SATA interface, a control circuit for preventing a supply voltage from being applied to a plurality of contact terminals corresponding to the other.

The foregoing and/or other aspects and utilities of the present general inventive concept may also be achieved by providing a host apparatus including the USB/SATA common socket.

The foregoing and/or other aspects and utilities of the present general inventive concept may also be achieved by providing a storage medium includes the USB/SATA common socket.

The foregoing and/or other aspects and utilities of the present general inventive concept may also be achieved by providing a USB/SATA common interface including the USB/SATA common connector plug and the USB/SATA common socket.

The foregoing and/or other aspects and utilities of the present general inventive concept may also be achieved by providing an interface apparatus including a housing having a first surface and a second surface, a USB terminal unit formed on the first surface of the housing, and a SATA terminal unit formed on the second surface of the housing.

The housing, the USB terminal unit, and the SATA terminal unit may be formed in a single integrated body.

The housing may further include a substrate extended from a body of the housing, and the first surface and the second surface are formed on opposite sides of the substrate.

The housing may further include a first extension and a second extension extended from a first portion and a second portion of the housing, respectively, and the first surface and the second surface may be formed on the first extension and the second extension to face each other.

The interface apparatus may further include a slot having a first portion to indicate the USB terminal unit and a second portion to indicate the SATA terminal unit.

The USB terminal unit may include one or more USB contact terminals having a first dimension, and the SATA terminal unit may include one or more SATA terminal having a second dimension different from the first dimension.

The interface apparatus may further include a cable extended from the housing and having a conductive line having a first end connected to at least one of the USB terminal unit and the SATA terminal unit and a second end connectable to an external device.

The housing comprises a body of an electronic apparatus to transmit and receive data through at least one of the USB terminal unit and the SATA terminal unit.

The foregoing and/or other aspects and utilities of the present general inventive concept may also be achieved by providing an interface apparatus including a housing having a first surface and a second surface, a first terminal unit formed on the first surface of the housing and having a first type of an interface, and a second terminal unit formed on the second surface of the housing and having a second type of the interface.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIGS. 1A and 1B illustrate a Universal Serial Bus (USB) connector plug and a Serial Advanced Technology Attachment (SATA) connector plug, respectively;

FIGS. 2A and 2B are a plan view and a cross-sectional view illustrating contact terminals of a USB connector plug and a USB socket, respectively;

FIGS. 3A and 3B are a plan view and a cross-sectional view illustrating contact terminals of a SATA connector plug and a SATA socket, respectively;

FIGS. 4A and 4B are a plan view and a cross-sectional view illustrating contact terminals of a USB/SATA common connector plug which is used for both a USB and a SATA, according to an embodiment of the present general inventive concept;

FIGS. 5A and 5B are a plan view and a cross-sectional view illustrating contact terminals of a USB/SATA common socket which is used for both a USB and a SATA, according to an embodiment of the present general inventive concept;

FIG. 6 is a cross-sectional view illustrating a USB/SATA common connector plug which is used for both a USB and a SATA, according to another embodiment of the present general inventive concept;

FIG. 7 is a view illustrating connection between the USB/SATA common connector plug and the USB/SATA common socket according to an embodiment of the present general inventive concept;

FIG. 8 is a front view illustrating a slot for blind matching illustrated in FIGS. 4 and 6; and

FIGS. 9A, 9B, 9C, 9D, and 9E are views illustrating an interface system to connect a plug and a socket of an electronic apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, an interface system according to the present general inventive concept will be described in detail by explaining embodiments of the present general inventive concept with reference to the attached drawings.

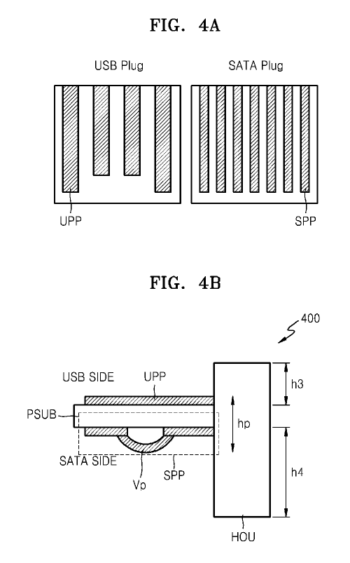

FIGS. 4A and 4B are a plan view and a cross-sectional view illustrating contact terminals of a Universal Serial Bus/Serial Advanced Technology Attachment (USB/SATA) common connector plug 400 which is used for both a USB and a SATA, according to an embodiment of the present general inventive concept.

Referring to FIGS. 4A and 4B, the USB/SATA common connector plug 400 includes a pin substrate PSUB, a plurality of USB contact terminals UPP, and a plurality of SATA contact terminals SPP. The pin substrate PSUB is formed of a non-conductive material and connected to a housing HOU, so as to support the contact terminals UPP and SPP with respect to the housing HOU and/or the pin substrate PSUB.

The pin substrate PSUB is extended from the housing HOU to have an upper height h3 and a lower height h4 to be spaced-apart from upper and lower ends of the housing HOU as illustrated in FIG. 4B.

The USB/SATA common connector plug 400 may have a height hp corresponding to a thickness of the USB contract terminal, the pin substrate PSUB, and the SATA contract terminals SPP, as illustrated in FIG. 4B.

The USB contact terminals UPP are formed on a first surface of the pin substrate PSUB. Meanwhile, the SATA contact terminals SPP are formed on a second surface of the pin substrate PSUB. That is, in the USB/SATA common connector plug 400, the USB contact terminals UPP and the SATA contact terminals SPP are respectively formed on both surfaces of the pin substrate PSUB.

A pattern of the USB contact terminals is different from a pattern of the SATA contact terminals SPP. In detail, each USB contact terminal UPP has a flat contact, and each SATA contact terminal SPP has a convex contact Vp.

The USB contact terminals may have different lengths in a coupling direction of the USB/SATA common connector plug, and the SATA contact terminals may have a same length. A width of the USB contact terminals may be different from a width of the SATA contact terminals. Also, the USB contact terminals may be disposed to be spaced-apart from each other at a first interval, and the SATA contact terminals may be disposed to be spaced-apart from each other at a second interval. Moreover, the number of the USB contact terminals may be different from the number of the SATA contact terminals. Accordingly, the USB/SATA common connector plug 400 may have different types of contact terminals for different interface connections in a single integrated (monolithic) body as illustrated in FIGS. 4A and 4B.

The USB/SATA common connector plug 400 can further include a cover to protect the USB and SATA contact terminals UPP and SPP. As illustrated in a cross-sectional view of a USB/SATA common connector plug 600 according to another embodiment of the present general inventive concept, the USB/SATA common connector plug 600 may include two covers UCOV and SCOV extended from a housing HOU.

The covers UCOV and SCOV may be formed of an elastic material to be movable or bent with respect to the housing HOU. However, the covers UCOV and SCOV have strength enough to cover and protect the USB and SATA contact terminals UPP and SPP. The cover UCOV is spaced apart from the contact terminal UPP by a first distance, and the cover SCOV is spaced apart from the contact terminal SPPP by a second distance. The second distance is longer than the first distance.

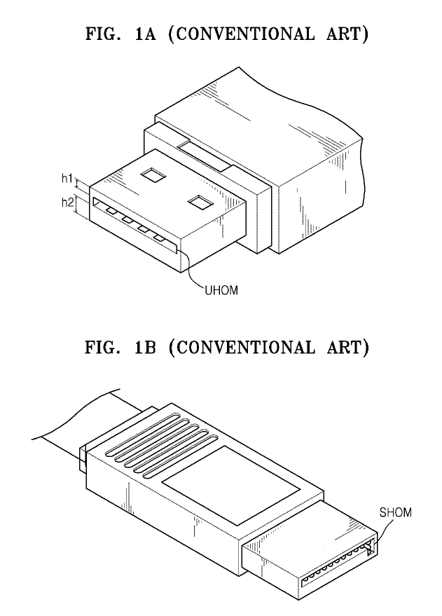

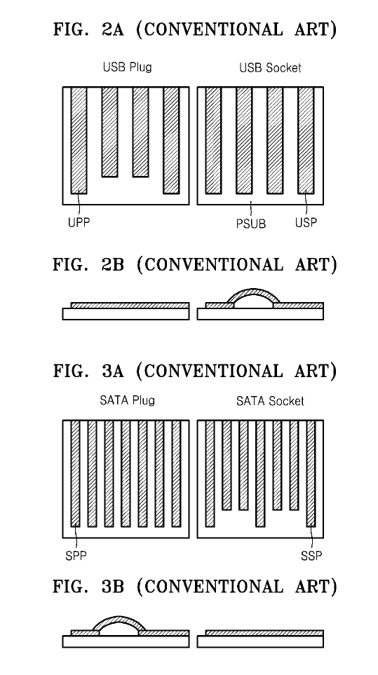

The USB/SATA common connector plugs 400 and/or 600 may have a housing HOU formed with a slot for blind matching of a USB interface and a SATA interface. As illustrated in FIGS. 1A and 1B, in a USB connector plug, a slot UHUM for blind matching is formed in a rectangular shape HOMa at an upper part of the USB connector plug. Also, in a SATA connector plug, a slot SHOM for blind matching has a “ [symbol] ”-shape, that is, a rectangular shape HOMa with a groove G. FIG. 8 is a front (cross-sectional) view schematically illustrating a USB/SATA common connector plug having a slot HOM for blind matching.

Referring to FIG. 8, in order to implement a slot HOM suitable for both blind matching of a USB interface and blind matching of a SATA interface, the slot HOM for blind matching is formed in a “ [symbol] ”-shape, that is, a rectangular shape with a groove G, at an upper part of a housing HOU. Since the slot HOM for blind matching is formed at the upper part of the housing HOU such that a height h7 is lower than a height h8, the first surface of a pin substrate PSUB is also positioned at the upper part of the housing HOU, so that the heights h7 and h8 may correspond to the heights h3 and h4 of FIG. 4, respectively.

As such, according to the current embodiments, by forming USB contact terminals and SATA contact terminals having different patterns on both surfaces of a pin substrate, respectively, a single connector plug can be used as both a USB interface and a SATA interface. Each of the USB/SATA common connector plugs 400 and 600 according to the current embodiments can be inserted into a USB/SATA common socket according to an embodiment of the present invention, as illustrated in FIG. 7.

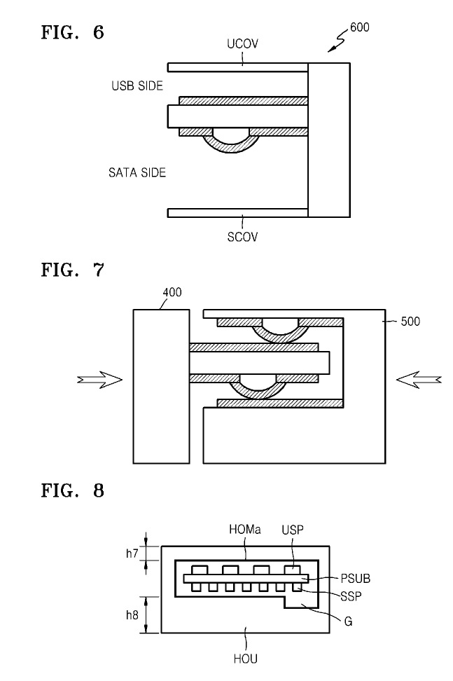

Also, each of the USB/SATA common connector plugs 400 and 600 can be inserted into both or either one of a USB socket and a SATA socket. Here, if the USB/SATA common connector plug 600 having the movable covers UCOV and SCOV illustrated in FIG. 6 is inserted into a SATA socket, the cover UCOV to protect the USB contact terminals can be deformed or bent to be sunk in the housing of the USB/SATA common connect plug 600. Likewise, if the USB/SATA common connector plug 600 having the covers UCOV and SCOV illustrated in FIG. 6 is inserted into a USB socket, the cover SCOV to protect SATA contact terminals can also be deformed or bent to be sunk in the housing.

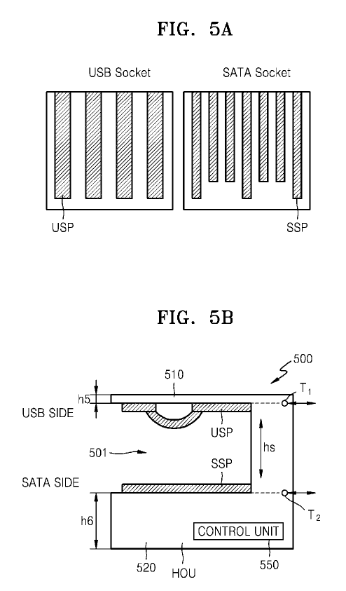

FIGS. 5A and 5B are a plan view and a cross-sectional view illustrating contact terminals of a USB/SATA common socket 500 which is used for both a USB and a SATA, according to an embodiment of the present general inventive concept.

Referring to FIGS. 5A and 5B, the USB/SATA common socket 500 includes a housing HOU, a plurality of USB contact terminals USP, a plurality of SATA contact terminals SSP, and a receptacle 501 defined by the housing HOU and the SATA contact terminals SSP and having a height hs corresponding to the height hp of FIG. 4B to receive the USB/SATA common plug 400 or 600. The USB contact terminals USP are formed on a first surface of the housing HOU and each USB contact terminal USP has a convex contact Vs. The SATA contact terminals SSP are formed on a second surface of the housing HOU and each SATA contact terminal SSP has a flat contact.

That is, the USB/SATA common socket 500 includes both the USB contact terminals USP and the SATA contact terminals SSP. Here, the first surface of the housing HOU is opposite to the second surface of the housing HOU.

The housing HOU can include a first extension 510 extended from a first portion of the housing HOU and a second extension 520 extended from a second portion of the housing HOU and spaced-apart from the first extension to define the receptacle 501, such that the USB contact terminals and the USP SATA contact terminals SSP are disposed on the first extension 510 and the second extension 520, respectively, to face each other with respect to an inside of the receptacle 501.

The USB/SATA common socket 500 may include a control unit to control connections (stitches) between the terminal USP and a terminal unit T1 and between the terminals SSP and a terminal unit T2 to control a power supply or a data transmission. That is, the control unit may turn off the power if necessary, for example, disconnection or termination of communication. This structure of the control unit may be included in the USB/SATA common plug 400.

In order to implement the USB/SATA common socket 500 so that it is suitable for blind matching of a USB interface and a SATA interface, a slot for blind matching of the USB/SATA common socket is formed in a “ [symbol] ”-shape at an upper part of the housing HOU to correspond to the slot for blind matching of the USB/SATA common plug.

The USB/SATA common socket 500 can further include a control circuit (not illustrated) to prevent a supply voltage from being applied to the other interface (that is, a non-contact interface) of the USB interface and SATA interface, when the USB/SATA common socket 500 contacts only one interface of the USB interface and the SATA interface.

As such, in the USB/SATA common socket 500 according to the current embodiment, since USB contact terminals and SATA contact terminals are respectively located with different patterns in an upper part and a lower part inside a housing, respectively, the USB/SATA common socket 500 can be used as both a USB interface and a SATA interface. Accordingly, both a USB plug and a SATA plug can be inserted into the USB/SATA common socket 500 according to the current embodiment. Also, the USB/SATA common socket 500 can be inserted into a USB/SATA common plug which will now be described in relation to FIG. 7.

FIG. 7 is a view illustrating connection of the USB/SATA common connector plug 400 of FIG. 4B and the USB/SATA common socket 500 of FIG. 5B according to an embodiment of the present general inventive concept.

Referring to FIG. 7, the USB/SATA common connector plug 400 and the USB/SATA common socket 500 may be connected to each other in arrow directions such that terminals are in contact with corresponding terminals. In detail, a first surface of a housing HOU of FIG. 5B is disposed to face a first surface of the USB/SATA common connector plug 400 of FIG. 4B, and a second surface of the housing HOU of FIG. 5B is disposed to face a second surface of the USB/SATA common connector plug 400. Accordingly, the USB contact terminals of the USB/SATA common connector plug 400 contact the UBS contact terminals of the USB/SATA common socket 500, and the SATA contact terminals of the USB/SATA common connector plug 400 contact the SATA contact terminals of the USB/SATA common socket 500.

According to the present general inventive concept, the USB/SATA common connector plug 400 may include a memory device connected to the terminals to receive data and store the received data from an external device through the terminals, and to transmit the stored data to the external device though the terminals. It is also possible that the USB/SATA common connector plug 400 may include a cable connected to the terminals and extended from the housing HOU, and the cable may be connected to an external device. In this case, the USB/SATA common connector plug 400 may not have a memory device. However, the present general inventive concept is not limited thereto. The USB/SATA common connector plug 400 may have the memory device and the cable.

According to an embodiment of the present general inventive concept, a connecting system may include a cable, an electronic apparatus such as a host apparatus, a storage medium, and a USB/SATA common interface which may have the same technical concept as the USB/SATA common connector plug 400 and the USB/SATA common socket 500 as described above.

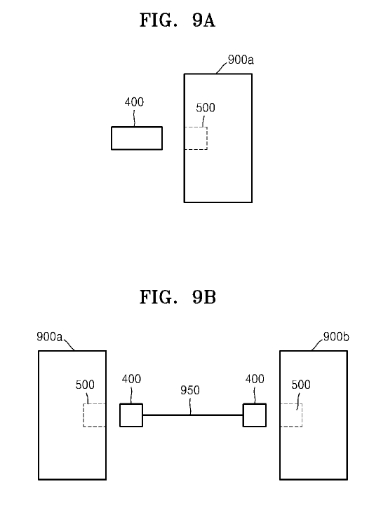

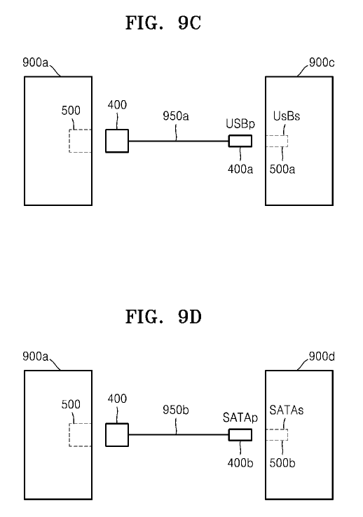

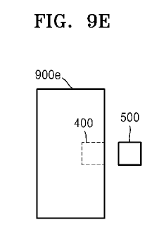

Referring to FIG. 9A, a connection system includes a host apparatus 900a having a USB/SATA common socket 500 to be connected to an external USB/SATA common connector plug 400.

Referring to FIG. 9B, a connection system includes a host apparatus 900a having a USB/SATA common socket 500, and a second host apparatus 900b having a second USB/SATA common socket 500. The connection system may further include a cable 950 and USB/SATA common connector plugs 400 formed on opposite ends of the cable 950. Here, the cable 950 includes one or more conductive lines connected between the terminals of the USB/SATA common connector plugs 400 to form a communication line between the USB/SATA common connector plugs 400.

Referring to FIG. 9C, a connection system includes a host apparatus 900a having a USB/SATA common socket 500, and a second host apparatus 900c having a USB socket 400a. The connection system may further include a cable 950a, a USB/SATA common connector plug 400 formed on one end of the cable 950a to be connected to the USB/SATA common socket 500 of the host apparatus 900a, and a USB plug 400a formed on the other end of the cable 950a to be connected to the USB socket 500a. Here, the cable 950a includes one or more conductive lines connected between the terminals of the USB/SATA common connector plug 400 and the USB plug 400a.

Referring to FIG. 9D, a connection system includes a host apparatus 900a having a USB/SATA common socket 500, and a second host apparatus 900d having a SATA socket 400b. The connection system may further include a cable 950b, a USB/SATA common connector plug 400 formed on one end of the cable 950b to be connected to the USB/SATA common socket 500 of the host apparatus 900a, and a SATA plug 400b formed on the other end of the cable 950b to be connected to the SATA socket 500b. Here, the cable 950b includes one or more conductive lines connected between the terminals of the USB/SATA common connector plug 400 and the SATA plug 400b. Here, the second host apparatus 900b, 900c, and 900d may be a storage medium connectable to the host apparatus 900a. It is also possible that the USB/SATA common plug 400 and the USB/SATA common socket 500 may include a memory device to store data received from an external device if necessary.

Referring to FIG. 5E, a connection system includes a host apparatus 900e having a USB/SATA common plug 400 to be connectable to a USB/SATA common socket 500. It is possible that the USB/SATA common socket 500 can have a memory device or can be connected to another host apparatus and/or or another memory device through a cable as illustrated in FIGS. 9A through 9D. Here, the host apparatus 900a through 900e may be a personal computer, a notebook, a Personal Digital Assistant (PDA), a wired or wireless phone, a game machine, a printer, a scanner, etc., to be connectable to a memory device or an external host apparatus to transmit and receive data therefrom.

As described above, in a USB/SATA common interface according to the present general inventive concept, by forming USB contact terminals and SATA contact terminals respectively having different patterns in a single plug or in a single socket, it is possible to reduce the layout size of a device and save resources.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A Universal Serial Bus/Serial Advanced Technology Attachment (USB/SATA) common connector plug to interface between a host apparatus and a storage medium, comprising:
a housing;
a pin substrate connected to the housing and formed of a non-conductive material;
a plurality of USB contact terminals formed in a first pattern on a first surface of the pin substrate; and
a plurality of SATA contact terminals formed in a second pattern which is different from the first pattern, on a second surface of the pin substrate.

2. The USB/SATA common connector plug of claim 1, wherein the first pattern is a flat pattern, and the second pattern is a convex pattern.

3. The USB/SATA common connector plug of claim 1, further comprising:
a movable cover connected to the housing to protect the USB contact terminals.

4. The USB/SATA common connector plug of claim 3, wherein, when the USB/SATA common connector plug is inserted into an external SATA socket, the cover is sunk in the housing.

5. The USB/SATA common connector plug of claim 1, further comprising:
a movable cover connected to the housing to protect the SATA contact terminals.

6. The USB/SATA common connector plug of claim 4, wherein, when the USB/SATA common connector plug is inserted into an external USB socket, the cover is sunk in the housing.

7. The USB/SATA common connector plug of claim 1, wherein the housing comprises a slot for blind matching of a USB interface and a SATA interface.

8. The USB/SATA common connector plug of claim 7, wherein the housing includes a first end surface and a second end surface having a height with the first end surface, and the first surface of the pin substrate is located near the first end surface of the housing.

9. The USB/SATA common connector plug of claim 8, wherein the slot for blind matching is located near the first end surface of the housing.

10. The USB/SATA common connector plug of claim 1, wherein the first surface and the second surface of the pin substrate are disposed opposite to each other with respect to the pin substrate.

11. A Universal Serial Bus/Serial Advanced Technology Attachment (USB/SATA) common socket to interface between a host apparatus and a storage medium, comprising:
a housing:
a plurality of USB contact terminals formed in a second pattern on a first surface of the housing; and
a plurality of SATA contact terminals formed in a first pattern which is different from the second pattern, on a second surface of the housing.

12. The USB/SATA common socket of claim 11, further comprising:
a movable cover to protect the USB contact terminals; and
a movable cover to protect the SATA contact terminals.

13. The USB/SATA common socket of claim 11, further comprising:
when the USB/SATA common socket is connected to one of a USB interface and a SATA interface, a control circuit to prevent a supply voltage from being applied to a plurality of contact terminals corresponding to the other one of the USB interface and the SATA interface.

14. An interface apparatus comprising:
a housing having a first surface and a second surface;
a USB terminal unit formed on the first surface of the housing; and
a SATA terminal unit formed on the second surface of the housing,
wherein the housing, the USB terminal unit, and the SATA terminal unit are formed in a single integrated body.

15. The interface apparatus of claim 14, wherein the housing further comprises a substrate extended from a body of the housing, and the first surface and the second surface are formed on opposite sides of the substrate.

16. The interface apparatus of claim 14, wherein the housing further comprises a first extension and a second extension extended from a first portion and a second portion of the housing, respectively, and the first surface and the second surface are formed on the first extension and the second extension to face each other.

17. The interface apparatus of claim 14, further comprising:
a slot having a first portion to indicate the USB terminal unit and a second portion to indicate the SATA terminal unit.

18. The interface apparatus of claim 14, wherein the USB terminal unit comprises one or more USB contact terminals having a first dimension, and the SATA terminal unit comprises one or more SATA terminal having a second dimension different from the first dimension.

19. The interface apparatus of claim 14, further comprising:
a cable extended from the housing and having a conductive line having a first end connected to at least one of the USB terminal unit and the SATA terminal unit and a second end connectable to an external device.

20. The interface apparatus of claim 14, wherein the housing comprises a body of an electronic apparatus to transmit and receive data through at least one of the USB terminal unit and the SATA terminal unit.
